(19) United States
(12) Patent Application Publication
(10) Pub. No.: US 2007/0116968 A1
(43) Pub. Date: May 24, 2007

(54) Hydrophilic coating based on polysilazane

(76) Inventors: Andreas Dierdorf, Hofheim (DE); Hubert Liebe, Wiesbaden (DE); Andreas Wacker, Mannheim (DE); Gunter Motz, Bayreuth (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 10/585,392

(22) PCT Filed: Dec. 16, 2004
(86) PCT No.: PCT/EP04/14326

§ 371 Date: Jul. 6, 2006

(30) Foreign Application Priority Data
Jan. 7, 2004 (DE) 10 2004 001 288.1

(51) Int. Cl. B05D 3/00; B05D 7/00; B32B 9/04; C08G 77/26

(52) U.S. Cl. 428/446; 427/331; 427/402; 528/38

(57) ABSTRACT

The invention relates to a hydrophilic coating for surfaces containing one or several polysilazanes and an ionic reagent or mixtures of ionic reagents. The polysilazane is, in particular, a polysilazane of the formula —(SiR′R″—NR′″)ₙ— (1),wherein R′, R″, R′″ can be identical or different and are either hydrogen or organic or metalorganic radicals, n is measured in such a manner that the polysilazane has a numerical average molecular weight ranging from 150 to 150 000 g/mol. In a preferred embodiment, the polysilazane is perhydropolysilazane (R′=R″=R′″=H). The ionic reagent is, preferably, a salt of a carboxylic acid, in particular of a hydroxycarboxylic acid, or a cationic or anionic silane, or an oligomer or polymer. The invention also relates to a method for the production of the above-mentioned hydrophilic coatings.

The present invention relates to a transparent, permanently hydrophilic coating based on polysilazane in combination with an ionic reagent for increasing the hydrophilicity.

Hydrophilic surfaces are characterized by good wettability with water which is measurably revealed in a small contact angle. Such hydrophilic surfaces are suitable, for example, as antimist finishing for mirrors, car windscreens and the like and also for the production of easy-to-clean surfaces, where the wetting water film washes away any dirt particles which are present.

Various options are known in the literature for producing hydrophilic surfaces depending on the substrate.

Firstly, certain detergents are suitable for temporarily imparting hydrophilicity to surfaces. Such formulations have been obtainable for a long time and are used, inter alia, as antimist compositions for spectacles and optical devices, although these compositions do not adhere to the surface and therefore exhibit an effect for only a short time.

EP-0 498 005 A1 describes an aqueous/alcoholic formulation based on a vinylpyrrolidone/vinyl acetate copolymer which is used as antimist composition for spectacles.

Other hydrophilic coating materials consist of organic polymers or copolymers which contain polar groups. These coatings are characterized by the fact that they are able to absorb water and thus the surface is wetted with a water film. A disadvantage of such coatings is their low abrasion resistance, and the absorption of water also leads to swelling of the polymer, which brings about detachment or release from the surface. Moreover, either UV curing or thermal treatment is necessary for curing such polymeric systems, which, on the one hand, is associated with high technical expenditure and thus with costs and, on the other hand, is unsuitable for heat-sensitive substrates.

EP-0 339 909 B1 describes a thermally curable coating composition which comprises polar copolymers which are constructed from condensates of methacrylamide and further hydrophilic monomers. This formulation is applied to polycarbonate and PMMA and cured at 80-120° C.

EP-1 118 646 A1 describes a UV-curable coating composition with mist-reducing properties based on polyalkylene oxide di(meth)acrylates, hydroxyalkyl (methacrylates) and alkanepolyol poly(methacrylates) which, when applied to polycarbonate sheets and cured, leads to a reduction in misting.

Finely divided titanium dioxide particles in the anatase modification have photocatalytic properties and are also suitable for hydrophilically modifying surfaces. However, the photocatalytic effect and the hydrophilicity associated with it only arises if these particles are subjected to UV irradiation, i.e. they are not suitable for use in interiors. Furthermore, due to their photocatalytic activity, these particles have a tendency to destroy organic substrates or binder systems in their vicinity over time. Corresponding titanium dioxide particles are thus only suitable for use on inorganic substrates.

EP-0 913 447 A1 describes a formulation based on photocatalytically active nano-metal oxides which, when applied to a pane of glass and following irradiation with UV light, exhibits no misting at all when it is breathed on. In application example A1, the adhesion of this antimist coating is tested, where after rubbing two to three times with an eraser the coating can be completely removed.

Silicatic surfaces such as glass and ceramic or surfaces made of metal oxide can be coated with halo- or alkoxysilanes which carry hydrophilic substituents. These react with the oxidic surface and in so doing are covalently bonded. As a result of the chemical bond between the substrate and the silane, the hydrophilic substituents are permanently fixed to the surface and their effects are retained. U.S. Pat. No. 6,489,499 B1 describes a method for producing a hydrophilically modified glass surface in which a solution of a siloxane-modified ethylenediaminetricarboxylic acid salt is used. In this method, however, no quantitative statement is made about the contact angle, it merely being established that the wetting of a coated glass surface to which a drop of water is applied is better than without coating. A disadvantage is that these silanes do not react with surfaces which do not contain oxide or hydroxide groups. For example, plastics, paints and resins can not be finished with a hydrophilic effect using the hydrophilic silanes. A further disadvantage of these hydrophilizing reagents is that, due to their low molar mass, on very absorbent surfaces or surfaces with large pores they diffuse into the substrate without sufficiently covering the surface with a hydrophilic effect.

Polysilazanes are suitable for producing thin layers with which substrates can be protected, for example, against scratching or corrosion. WO 02/088269 A1 describes a soil-repelling coating solution based on polysilazane, but without after-treatment with a further hydrophilizing reagent. The mere coating of a surface with polysilazane and subsequent curing in the air gives relatively hydrophilic surfaces which have a contact angle of 30-40° C.

In summary, it can be established that the systems known in the art for producing hydrophilic surfaces are either unable to also maintain this hydrophilicity permanently or cannot be used universally on the most diverse of surfaces and/or have the disadvantage that the coating can be achieved only by curing at elevated temperatures or by irradiation with UV light, which firstly is associated with increased expenditure and furthermore is unsuitable for heat-sensitive substrates.

The object of the present invention was to develop an easy-to-apply coating with which it is possible to provide the most diverse of materials, such as glass, ceramics, metals, plastics, paints, resins and porous surfaces, with a permanent hydrophilic effect.

Surprisingly, it has now been found that combining polysilazanes with an ionic reagent, surfaces can be provided with a permanent hydrophilic effect which is significantly superior to that for a straight polysilazane coating.

The invention therefore provides a hydrophilic coating for surfaces comprising one or more polysilazanes and an ionic reagent or mixtures of ionic reagents for increasing the hydrophilicity. By applying ionic reagents to the polysilazane coat, charge is fixed to the substrate surface, which leads to a surface with high surface energy, which permits easy wetting with water. Here, it is unimportant whether the charge is cationic or anionic. Polysilazanes are very reactive inorganic or organic polymers which, due to this high reactivity, firstly adhere very well to the most diverse of surfaces by entering into permanent chemical bonds and furthermore are able to enter into a chemical reaction with other applied reagents and thus likewise permanently bind these reagents.

According to the invention, the hydrophilic coating comprises at least one polysilazane of the formula 1,
—(SiR′—NR″—R′″)ₙ— (1)
where R′, R″, R′″ may be identical or different and are either hydrogen or organic or organometallic radicals and in which n is such that the polysilazane has a number-average molecular weight of from 150 to 150 000 g/mol, preferably perhydropolysilazane (R′=R″=R′″=H), in which n is such that the perhydropolysilazane has a number-average molecular weight of from 150 to 150 000 g/mol.

The hydrophilizing agents are ionic compounds which are generally applied in dissolved form to the initially applied polysilazane coating, react with it and therefore permanently adhere to it. These may be the most diverse of reagents which permit the desired permanent hydrophilic effect in combination with the polysilazane coating.

These ionic hydrophilizing agents may, for example, be salts of carboxylic acid, in particular of hydroxycarboxylic acid, such as calcium, sodium or potassium gluconate, salts of tartaric acid, citric acid, malic acid, lactic acid or sugar acid. Solutions of these salts can also-be obtained directly by reacting the corresponding acid with alkalis.

In addition, substituted ionic halo-, hydroxy-, alkoxy- or alkylsilanes, such as N-(trimethoxysilylpropyl)ethylenediaminetriacetic acid trisodium salt, N-trimethoxysilylpropyl-N,N,N-trimethylammonium chloride, N-(3-triethoxysilylpropyl )gluconamide, N-(triethoxysilylpropyl )-O-polyethylene oxideurethane, 1-trihydroxysilylpropionic acid disodium salt, are suitable hydrophilizing agents.

Ionic oligomers or polymeric compounds, such as surfactants or dispersion additives, such as Byk®-151, Byk®-LP N 6640, Anti-Terra®-203, Disperbyk®-140, Byk®-9076, Byk®-154, Disperbyk®, Disperbyk®-181, are likewise suitable hydrophilizing agents.

Also suitable are salts, such as titanium phosphate which, like the anatase modification of titanium dioxide, become “superhydrophilic” as a result of irradiation with UV light. However, compared with anatase, titanium phosphate has the advantage that it is not as aggressive toward organic materials and does not destroy them.

A common feature of all of these hyrophilicizing auxiliaries is that the contact angle of a surface coated with polysilazane is smaller than is observed without the use of these reagents.

The invention further provides a method for producing a hydrophilic coating comprising one or more polysilazanes and an ionic reagent or mixtures of ionic reagents where, in a first step, a surface is coated with at least one polysilazane and then, in a second step, an ionic hydrophilizing reagent or mixtures of ionic hydrophilizing reagents in a solvent are applied.

The polysilazanes used are, in particular, the abovementioned compounds. The invention further provides a hydrophilic surface obtainable by coating with the abovementioned polysilazanes and ionic hydrophilizing reagents.

Using the hydrophilic coatings according to the invention it is possible to coat a large selection of substrate surfaces. Suitable substrates are, for example:
metals, such as, for example, iron, stainless steel, galvanized steel, zinc, aluminum, nickel, copper, magnesium and alloys thereof, silver and gold,
plastics, such as, for example, polymethyl methacrylate, polyurethane, polycarbonate, polyesters, such as polyethylene terephthalate, polyimides, polyamides, epoxy resins, ABS polymer, polyethylene, polypropylene, polyoxymethylene,
porous mineral materials, such as concrete, clay bricks, marble, basalt, asphalt, loam, terracotta
coated surfaces such as, for example, plastics emulsion paints, acrylic coatings, epoxy coatings, melamine resins, polyurethane resins and alkyd coatings and
organic materials, such as wood, leather, parchment, paper and textiles
glass, to name but a few.

The coating with polysilazane can take place by wiping, immersion, spraying or spin coating of straight polysilazane or a polysilazane solution. To achieve the desired hydrophilic effect, only a thin coat of polysilazane is necessary, which is transparent and therefore does not adversely affect the optical appearance of the substrate. Due to the small coat thickness, only a very small amount of material is required, which is advantageous both in terms of cost and also ecologically, and the substrate to be coated becomes only slightly heavier. The coat thickness of the polysilazane coat following evaporation of the solvent and curing is in the range from 0.01 to 10 micrometers, preferably 0.05 to 5 micrometers, particularly preferably 0.1 to 1 micrometer. Here, it is possible to firstly pretreat the surface to be coated with a primer.

The subsequent coating with the hydrophilizing agent can likewise take place by immersion, spraying, spin coating or wiping.

Both the coating with polysilazane and also the subsequent application of the ionic reagent preferably takes place at a temperature in the range from 5 to 40° C., application at room temperature being particularly advantageous, which also permits the coating of heat-sensitive substrates.

By slightly heating the solution containing the ionic reagent the coating time can be shortened considerably.

The surfaces provided with the hydrophilic coating consisting of polysilazane and further hydrophilizing agent are characterized by a significantly lower tendency to misting and an easier-to-clean surface. The coating also has antigraffiti properties. Thus, for example water-resistant Edding pen marks can be removed easily with warm water or steam.

Suitable solvents for polysilazane are in particular organic solvents which contain no water and no reactive groups (such as hydroxyl or amine groups). These are, for example, aliphatic or aromatic hydrocarbons, halogenated hydrocarbons, esters, such as ethyl acetate or butyl acetate, ketones, such as acetone or methyl ethyl ketone, ethers, such as tetrahydrofuran or dibutyl ether, and mono- and polyalkylene glycol dialkyl ethers (glymes) or mixtures of these solvents.

A further constituent of the polysilazane solution may be catalysts, such as tertiary amines, which increase the curing rate of the polysilazane film, or additives which facilitate substrate wetting or film formation.

Suitable solvents for the hydrophilizing reagent are in particular water, alcohols, such as methanol, ethanol, isopropanol, ketones, such as acetone or methyl ethyl ketone, carboxylic acids, such as formic acid, acetic acid or propionic acid, and esters, such as ethyl acetate or butyl acetate or mixtures of these solvents.

### EXAMPLES

The coatings with polysilazanes were carried out under an inert-gas atmosphere in a glove box for better reproducibility. The various substrates were coated using an immersion apparatus. The contact angle measurements were carried out using an instrument from Krüss.

The polysilazane used was perhydropolysilazane in various solvents. Mixtures of xylene and Pegasol (designation NP) or di-n-butyl ether (designation NL) are customary. Manufacturer is Clariant Japan K.K.

### Experiment 1

A polycarbonate sheet (10×10 cm) was immersed into a 20% strength perhydropolysilazane solution in n-dibutyl ether in a glove box using an immersion apparatus with step motor at a rate of 20 cm/min. After a residence time of 10 s, it was drawn out of the solution again at a speed of 20 cm/min. It was allowed to drip briefly and then the sample was removed from the glove box. The sample was left lying exposed to air for 10 min and then immersed into an aqueous solution (10% strength) of the additive Byk-LP N-6640 (original solution is 40% strength, dilute 3:1 with water). The sample is left lying in the solution for 24 h and then rinsed with water.

The contact angle of water could not be determined exactly, but was considerably less than 10°.

On a half-coated polycarbonate sheet marks were made using a pen of make Staedtler Permanent Marker 352 (water-resistant) on the coated and uncoated surface. The marks on the coated side could be removed without problems using warm water or steam and a paper towel.

### Experiment 2

A V2A stainless steel sample was coated with a 20% strength perhydropolysilazane in xylene/pegasol AN45 in accordance with the method described above. The sample was then aged in air for 1 hour and immersed in an aqueous solution of the additive Byk-LP N-6640 for 24 hours. It was then rinsed with water. The contact angle of water is significantly less than 10°.

### Experiment 3

A V2A stainless steel sample was coated as described above. The aqueous solution of the Byk additive was heated to 50° C. and the steel sample was immersed for 30 min. The contact angle of water was significantly less than 10°.

### Experiment 4

Using a stainless steel sample the experiment was as described in experiment 2. Instead of the Byk additive, the sample was immersed into an aqueous, saturated Ca gluconate solution. After 24 hours, a contact angle of less than 10° was measured.

### Experiment 5

Using a stainless steel sample, the procedure was as described in experiment 4. The saturated Ca gluconate solution was heated to 50° C. and the sample was aged for 30 min. The contact angle of water was significantly less than 10°.

### Experiment 6

Using a stainless steel sample, the procedure was as described in experiment 2. Instead of the Byk additive, the sample was immersed into a 10% strength aqueous solution of the disodium salt of carboxyethylsilanetriol for 24 hours. The contact angle of water was less than 10°.

### Experiment 7

Using a stainless steel sample, the procedure was as described in experiment 2. Instead of the Byk additive, the sample was immersed into a 1% strength aqueous solution of titanium phosphate. After an aging time of 24 hours, the contact angle of water on the coated stainless steel sample was 32° . The sample was then irradiated with UV light for 12 hours, the contact angle decreased to 13°.

1. A hydrophilic coating for a surface comprising a) a coating including one or more polysilazanes and b) a coating including a salt of a carboxylic acid, a cationic or anionic silane, an oligomer or a polymer.

2. The hydrophilic coating as claimed in claim 1, wherein the one or more polysilazanes comprises at least one polysilazane of the formula 1,
—(SiR′R″—NR′″)ₙ— (1)
wherein R′, R″, R′″ are identical or different and are hydrogen, an organic radical or an organometallic radical and wherein n is such that the polysilazane has a number-average molecular weight of from 150 to 150 000 g/mol.

3. The hydrophilic coating as claimed in claim 2, wherein the one or more polysilazanes is a perhydropolysilazane.

4. The hydrophilic coating as claimed in claim 1, wherein the coating b) includes a salt of a carboxylic acid, and the hydrophilicity of the surface being coated can be increased by irradiation with UV light.

5. A method for producing a hydrophilic coating on a surface, comprising one or more polysilazanes and an ionic reagent or mixtures of ionic reagents comprising the steps of, coating a surface with at least one polysilazane second and second applying an ionic hydrophilizing reagent or mixtures of ionic hydrophilizing reagents in a solvent to the coating.

6. The method as claimed in claim 5, wherein the one or more polysilazane used is at least one polysilazane of the formula 1
—(SiR′R″—NR′″)ₙ— (1)
wherein R′, R″, R′″ are identical or different and are hydrogen, organic radicals or organometallic radicals and in which n is such that the one or more polysilazane has a number-average molecular weight of from 150 to 150 000 g/mol.

7. The method as claimed in claim 6, wherein the one or more polysilanzanes is in the form of a solution in an inert organic solvent and, optionally, also comprise a catalyst an additive or a mixture thereof for improving the surface wetting, film formation or both.

8. The method as claimed in claim 5, wherein the ionic hydrophilizing reagent or mixture of hydrophilizing reagents used is a salt of a carboxylic acid, a cationic or anionic silane, an oligomer, a polymer or a mixture thereof.

9. The method as claimed in claim 5, wherein the ionic hydrophilizing reagent or mixture of hydrophilizing reagents used is one or more inorganic salts whose effectiveness with respect to the hydrophilicity of the surface can be increased by irradiation with UV light.

10. The method as claimed in claim 5, wherein the ionic hydrophilizing reagent or mixture of hydrophilizing agents are dissolved in one or more solvents selected from the group consisting of: water, alcohol, ketone, carboxylic acid, ester or mixtures thereof.

11. The method as claimed in claim 5, wherein the surface to be coated is selected from the group consisting of: metal, plastic, porous mineral materials, paint- or resin-like surface, coated surfaces, organic material and glass.

12. The method as claimed in claim 5, wherein the surface is coated with the pure polysilazane or polysilazane solutions and the polysilazane coat thickness following evaporation of the solvent and curing is in the range from 0.01 to 10 micrometers.

13. The method as claimed in claim 13, further comprising the step of pretreating the surface with a primer prior to coating with the polysilazane or the polysilazane solution.

14. The method as claimed in claim 5, wherein the method is carried out at a temperature in the range from 5 to 40° C.

15. A hydrophilic coating for a surface as claimed in claim 1, wherein the salt of a carboxylic acid is the salt of hydroxycarboxylic acid.

16. A substrate having a surface, wherein the surface is coated with a hydrophilic coating according to claim 1.

17. The substrate as claimed in claim 16, wherein the substrate is selected from the group consisting of metals, plastics, porous mineral materials, paint or resin coated substrates, coated substrates, organic materials and glass.

18. The method as claimed in claim 5, wherein the ionic hydrophilizing reagent is hydroxycarboxylic acid.

19. A substrate having a surface, wherein the surface includes hydrophilic coating produced in accordance with the method of claim 5.

20. The substrate according to claim 19, wherein the substrate is selected from the group consisting of metal, plastic, porous mineral materials, paint- or resin-like substrates, coated substrates,organic material and glass.
